(19) United States
(12) Patent Application Publication
(10) Pub. No.: US 2011/0184915 A1
(43) Pub. Date: Jul. 28, 2011

(54) CLUSTER RESTORE AND REBUILD

(75) Inventors: Zhongwei Wu, Sammamish, WA (US); Oliver N. Seeliger, Sammamish, WA (US); Santeri Olavi Voutilainen, Seattle, WA (US); Ajay Kalhan, Redmond, WA (US); Sandeep Lingam, Bellevue, WA (US)

(73) Assignee: Microsoft Corporation, Redmond, WA (US)

(21) Appl. No.: 12/695,166

(22) Filed: Jan. 28, 2010

(51) Int. Cl. G06F 17/30

(52) U.S. Cl. 707/674; 707/E17.007; 707/E17.005

(57) ABSTRACT

Architecture that facilitates the restoration of a cluster database in a scalable way using backups (e.g., SQL database backups) and a partition rebuild mechanism to achieve a high level of partition level data consistency, even when restore fails on individual machines and/or machine failure occurs. The architecture restores replicas of the partitions in consideration that the backups may be created at different points and at different times. Optimized parallelism is achieved in restoring each database machine using local backups, which eliminates cross-machine network traffic. Thus, fast recovery of the distributed database can be accomplished on the order of hours over thousands of machines and terabytes of data.

### BACKGROUND

Large distributed database systems can run on thousands of machines. Due to application or system errors, data corruption can be widespread across the entire cluster. It is desirable that the distributed database system have the capability to restore the entire cluster to a consistent previous point in time while maintaining a strict recovery time objective (RTO) goal to minimize adverse business impact. The challenge is to restore a large number of machines hosting enormous amounts of data with partition level consistency under RTO goals of hours, for example.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the restoration of a large distributed database cluster in a scalable way using backups (e.g., SQL database backups) and a partition rebuild mechanism to achieve a high level of partition level data consistency, even when restore fails on individual machines and/or machine failure occurs. The architecture restores replicas of the partitions in consideration that the backups may have been created at different points and at different times. Optimized parallelism is achieved in restoring each database machine using local backup files, which eliminates cross-machine network traffic. Thus, fast recovery of the distributed database can be accomplished on the order of hours over thousands of machines and terabytes of data.

In such large distributed database environments (e.g., cluster), a central management component can be employed to maintain high availability of the data and machines. If there is a need to restore the distributed database cluster, the architecture facilitates the restoration and rebuild of the local machines from backups and then the central component from the restored/rebuilt local machines (a “from the ground up” reconstruction).

A partition (e.g., a unit of scale-out in a distributed database system, and is defined to include a transactionally consistent unit of schema and data) includes a primary replica and zero or more secondary replicas. Replicas are hosted on multiple machines to protect against hardware and software failures. Change data of the primary replica is replicated to multiple secondary replicas. A quorum of the secondary replicas acknowledges that the change data that has been received has also been committed, and thus, the data among the primary and secondary replicas is the same.

The database is restored simultaneously on each database machine using a database restore operation for maximum parallelism, and then partition rebuild is invoked to bring each data partition to a consistent point in time specified by a recovery point objective. Thereafter, any partitions in quorum loss can be fixed by forcing the formation of a new configuration.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates computer-implemented database management system in accordance with the disclosed architecture.

FIG. 2 illustrates a flow block diagram of a protocol and system components that restore and rebuild replicas, and fix partitions.

FIG. 3 illustrates a computer implemented database management method in accordance with the disclosed architecture.

FIG. 4 illustrates additional aspects of the method of FIG. 3.

FIG. 5 illustrates additional aspects of the method of FIG. 3.

FIG. 6 illustrates a method of restoring a local machine.

FIG. 7 illustrates a method of processing master machines at the coordinator level.

FIG. 8 illustrates a block diagram of a computing system operable to execute fast cluster restore using backups and rebuild in accordance with the disclosed architecture.

FIG. 9 illustrates a schematic block diagram of a computing environment that performs fast cluster recovery using the disclosed backup and rebuild architecture.

### DETAILED DESCRIPTION

The disclosed architecture operates on partitions. A partition is a unit of scale-out in a distributed database system, and is defined to include a transactionally consistent unit of schema and data. Copies of a partition are replicas. Replicas can be placed on multiple machines to protect against data loss due to hardware and software failures. For example, a partition can comprise multiple replicas each of which is stored on a different machine. Each partition comprises one primary replica and zero or more secondary replicas, and each machine can have multiple replicas (either primary and/or secondary) from various different partitions. Backups are performed on each machine and stored locally. The backup can contain data from different partitions, since a single machine can store replicas from different partitions.

A problem is that there can be cluster wide disaster that results in widespread loss of data, the causes of which range from hardware failures, software bugs (e.g., software jobs run astray that delete massive amounts of data), human errors, and to malicious acts. Rather than restoring each partition one by one (serially), which is time-consuming and ineffective, the disclosed recovery approach is to recover the cluster “in place” on each database machine simultaneously without the need to go through any staging area.

An advantage is to achieve optimum parallelism in restoration on each database machine using local backup files and thereby eliminating across-machine network traffic. The time to completion depends on the size of the database (and in a SQL implementation, the backup data and number of transaction log files) that is utilized to be applied to cover the recovery point.

The disclosed architecture restores the database concurrently on each database machine using a database restore for optimum parallelism. A partition build mechanism is then invoked to bring each data partition to a consistent point in time specified by a recovery point objective. Thereafter, any partitions in quorum loss can be fixed by forcing the formation of a new configuration (reconfiguration). A configuration defines, for a given partition, the replicas and machines on which the replicas reside, as well as which replica is a primary replica and which are the secondaries (if exist). As indicated, this configuration can change (a reconfiguration) based on quorum loss and selection of a new primary replica and secondaries.

The partition rebuild mechanism includes a global partition map (GPM), which is the global information about the state of the data store (e.g., cloud-based). The map stores the set of machines which are part of the cluster, the partitions that exist, and the machine location of the different replicas for each partition. This is the data used by the clients to determine which machine to connect to for the client data needs, and by a partition manager to decide about reconfigurations.

Each individual local data machine stores a local partition map (LPM) which keeps track of the replicas of each partition the local machine hosts. The GPM is a reflection of the union of these LPMs. Hence, when an LPM reports as having a partition that the GPM does not have, an inconsistency between the GPM and the LPM is indicated and could indicate possible GPM data loss. The repair action recreates the GPM database, populates its static tables from the configuration provided, builds the dynamic tables based on the information from the LPMs, and recovers lost partitions.

The way of checking GPM consistency is by comparing the GPM to the each LPM. The LPM is the most recent information about the state of the cluster and is considered to be correct. A discrepancy between GPM and LPM is considered as a possible GPM failure, instructing the administrator to initiate GPM rebuild (a rebuild component).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

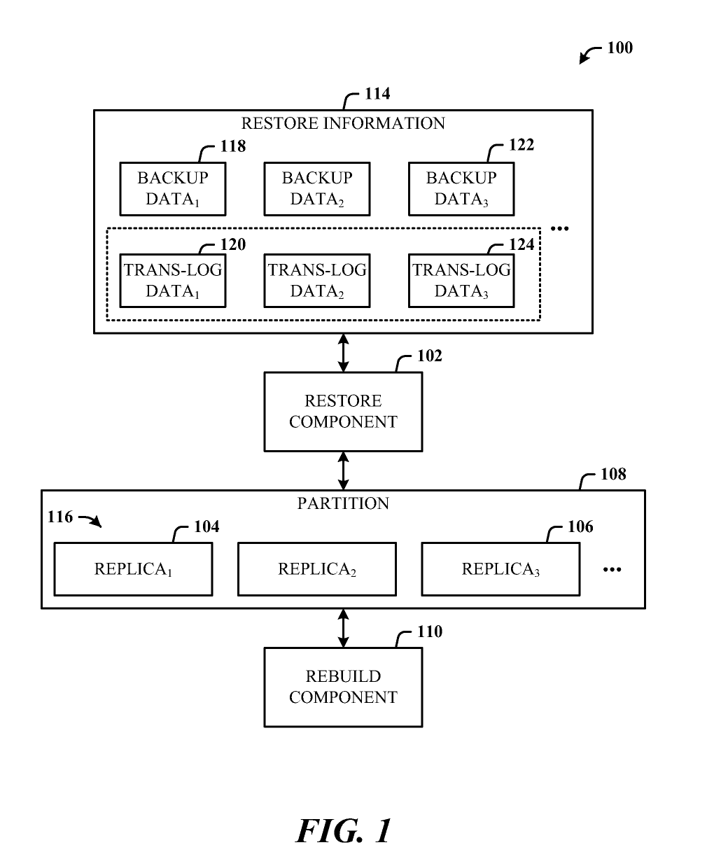

FIG. 1 illustrates a computer-implemented database management system 100 in accordance with the disclosed architecture. The system 100 includes a restore component 102 that restores replicas (e.g., a first replica 104 and a third replica 106), of a distributed database partition 108 of a local machine (not shown) in a distributed database system, and a rebuild component 110 that rebuilds the database partition 108 at the local machine into a transactionally consistent partition 112, where all replicas are rebuilt to the same point (e.g., in time).

Each replica of a local machine, after restoration, is transactionally consistent on its own, to a local time t. The local time t for each replica of the partition, as hosted on different machines, can be different. Thus, replicas having different local times are not “commonly” consistent relative to each other. When the local time t is the same for all replicas of a partition hosted across multiple local machines, the partition is referred to as “in a consistent state” or “a transactionally consistent partition”.

Data operations on a replica that were not captured in the LPM of the local machine, or that were captured in the LPM, but not updated to the GPM cause a discrepancy between the partition maps. In other words, discrepancy in terms of maps can occur when the partition configurations (composition of replicas), as defined in the LPM and the GPM, do not match.

The system 100 includes restore information 114, which includes backup data (and in the implementation of a distributed relational database using SQL, transaction log backup data) for each of the replicas 116 of the partition 108. For example, a set of backup data 118 (and optionally, transaction log data 120) is captured and stored for the first replica 104. Corresponding data occurs similarly for the other replicas of the partition 108.

The restore component 102 retrieves and applies the set of backup data 118 (and optionally transaction log data 120 for a SQL implementation) for the first replica 104 as part of the restore operation. Similarly, the restore component 102 can retrieve and apply other sets of backup data for replicas, as needed, for example, a third set of backup data 122 (and optionally transaction log data 124) for the third replica 106 as part of the restore operation.

In other words, this overall cluster recovery process utilizes specific processes to occur concurrently, thereby significantly reducing the downtime of the cluster (or portions thereof). Thus, generally, the restore component 102 restores the replicas concurrently, retrieves the local backup data relative to a previous point in time. As previously indicated, the replicas 116 can be restored using a structured query language (SQL) restore operation, in a SQL implementation. The rebuild component 110 rebuilds the partition 108 to a same point (e.g., in time) across all replicas 116.

The rebuild component 110 also detects configuration conflicts between partitions (local machine and master machine) and selects the most recent configuration of the conflicted configurations. The restore component 102 can be a cluster restore service that further restores cluster master machines as well, based on consistency restored to and rebuilt across local machine partitions.

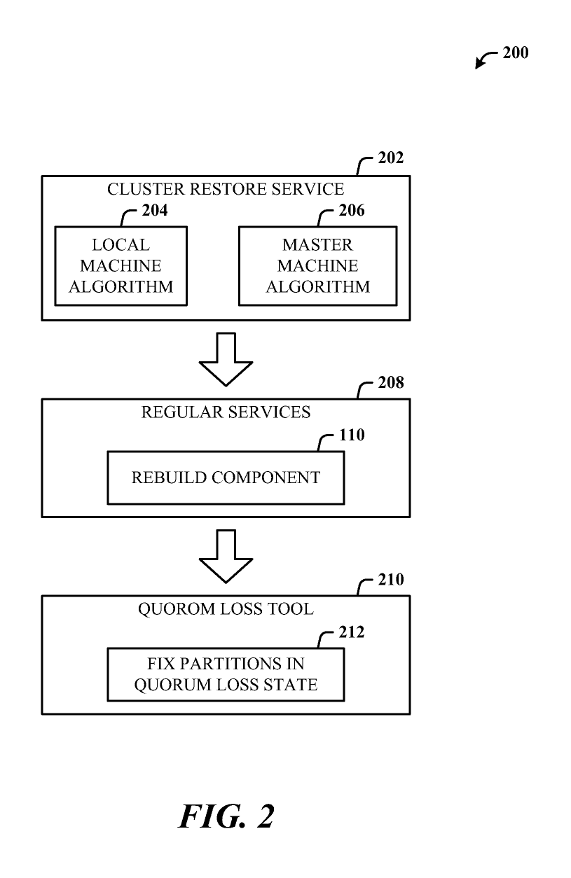

FIG. 2 illustrates a flow block diagram 200 of a protocol and system components that restore and rebuild replicas, and fix partitions. The diagram 200 begins with a cluster restore service (CRS) 202 that includes a local machine algorithm 204 and a master machine algorithm 206, among other possible algorithms, as desired for implementation. The cluster restore service 202 can receive time information back to which recovery is desired to be made. The local machine algorithm 204, as described below, operates in each local machine to drop the database off the cluster, search for the machine's restore information (e.g., backup data. and transaction log data where implemented for SQL), restore the machine locally, and report the success (or failure) of the machine restore to a cluster coordination manager. Similarly, the master machine algorithm 206 operates on each master machine to drop the GPM, and report the success (or failure) of the drop to the cluster coordination manager.

Once the restore service 202 completes for all given machines, one or more regular services 208 are applied, such as the rebuild component 110. As previously described, the rebuild component 110 takes the restored machines (with replicas) and rebuilds the local machines (the partitions thereof) to common consistency shared by all replicas of the same partition at the designated point in time. The diagram 200 also includes a quorum loss tool 210 that is invoked after rebuild to perform the operation of fixing partitions in a quorum loss state 212.

In other words, the workflow at a high level can be the following:
(1) define the point-in-time back to which the cluster is to be restored (e.g., in a format compatible with SQL date-time data type);
(2) deploy a CRS list which essentially drops a machine database and restores from local full backup data (and optionally, transaction log backup data for SQL) to the time;

At the end of this step, the machine database on each local machine may not be precisely at the same time because the clock on each machine may not be synched-up to the same time. It is possible that the restore operation can fail on some database machines due to various reasons, for example, the backup files are corrupted. Moreover, there can be in-flight reconfigurations proximate to the time that are captured as part of backup.

Continuing with the workflow,
(3) deploy a regular service list, and trigger the rebuild component (to rebuild the GPM); and
(4) invoke the quorum loss tool to fix all partitions in the quorum loss state.

In other cases, two sets of replicas can be restored, each of which reports a different configuration. For example, local machines A, B, and C are restored and report that the formation of a configuration with machine A as the primary replica of partition P. However, three other local machines D, E, and F with older backup files are also restored and report the formation of another configuration with D as primary replica for the same partition P. This could happen because the CRS may restore each machine to different time t. Thus, there can be the case that backup files in local machines D, E, and F do not yet include the latest configuration of partition P. The rebuild protocol of the rebuild component 110 is able to detect conflicting configurations and take the latest (most recent) partition configuration reported.

It may be the case that the CRS is unable to guarantee cluster wide data consistency to a time t, as different partitions could be restored to slightly different points in time other than time t; however, the data consistency is guaranteed at the partition level.

Put another way, the database management system employs a physical storage media, which includes a cluster restore service (CRS) in a distributed database system that facilitates concurrent restoration of replicas of distributed database partitions at local machines, and a rebuild component that rebuilds the distributed database partitions to common transactional consistency of the associated replicas for cluster-wide recovery. The CRS retrieves local backup data (and for a SQL implementation, transaction log backup data) relative to a previous point in time for restoring the replicas at the local machines. The CRS further facilitates rebuild of master replicas from partition state stored in the local machines. The system further comprises a quorum loss tool that when invoked fixes replicas in a quorum loss state. The rebuild component detects configuration conflicts between partitions and selects the most recent configuration.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

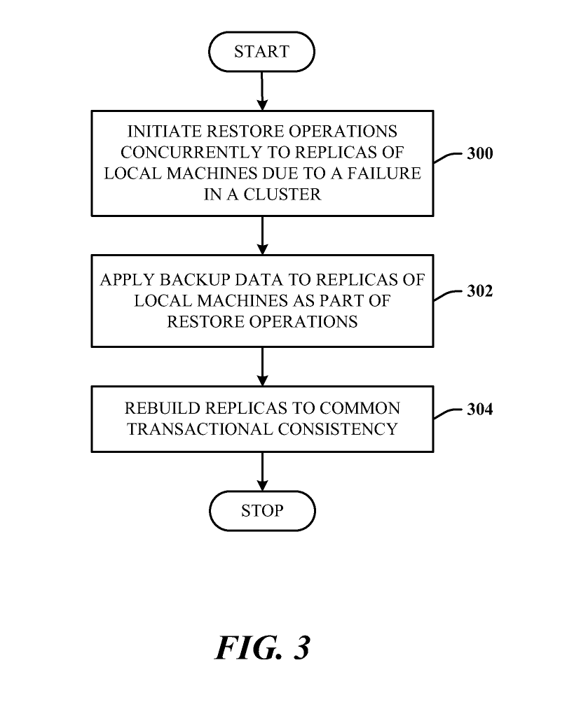

FIG. 3 illustrates a computer implemented database management method in accordance with the disclosed architecture. At 300, restore operations are initiated concurrently to replicas of local machines due to a failure in a cluster. At 302, backup data is applied to the replicas of the local machines as part of the restore operations. At 304, the replicas are rebuilt to common transactional consistency.

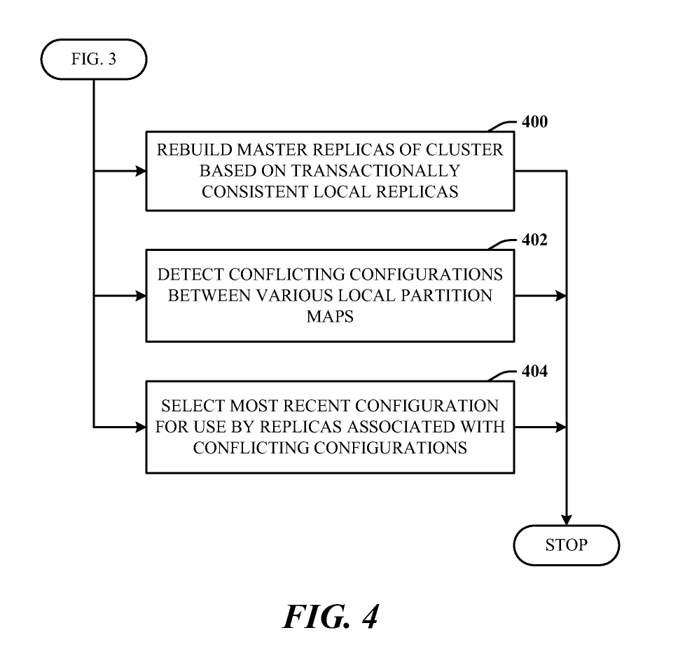

FIG. 4 illustrates additional aspects of the method of FIG. 3. At 400, master replicas of the cluster are rebuilt based on the transactionally consistent local replicas. At 402, conflicting configurations between local partition maps are detected. At 404, a most recent configuration is selected for use by replicas associated with the conflicting configurations.

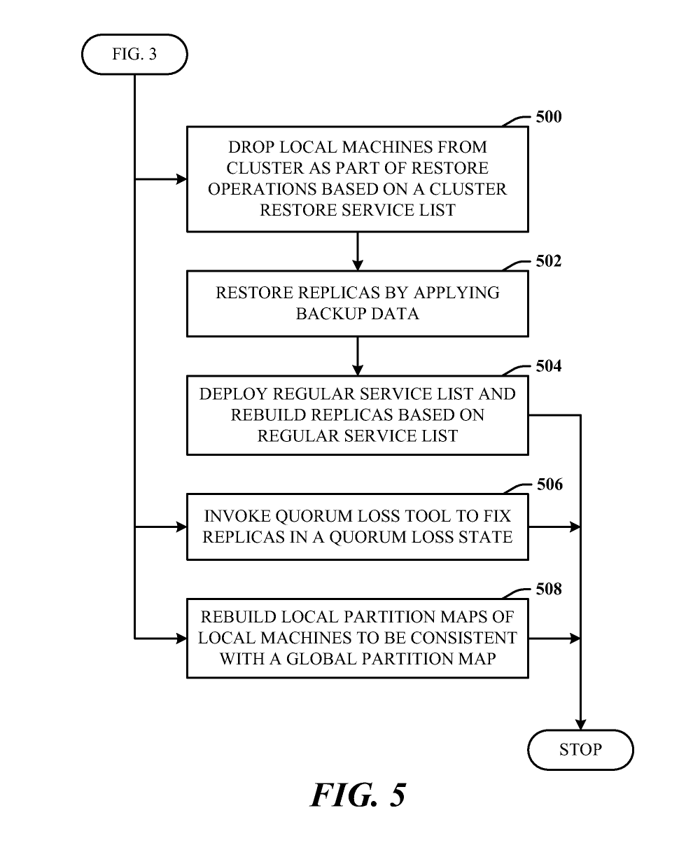

FIG. 5 illustrates additional aspects of the method of FIG. 3. At 500, the local machines are dropped from the cluster as part of the restore operations based on a cluster restore service list. At 502, the local machines are restored by applying the backup data and transaction log data. At 504, a regular service list is deployed and the local machines rebuilt based on the regular service list. At 506, a quorum loss tool is invoked to fix partitions in a quorum loss state. At 508, local partition maps of the local machines are rebuilt to be consistent with a global partition map.

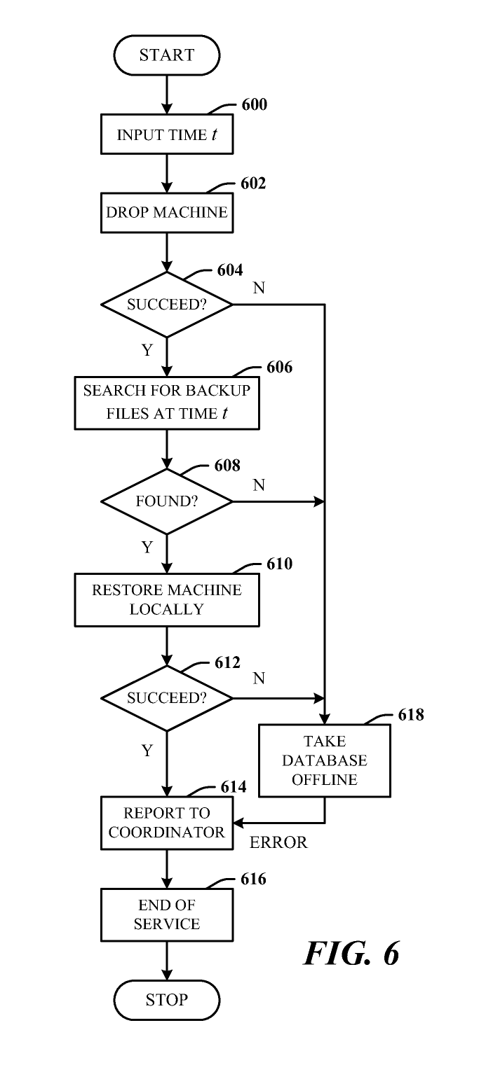

FIG. 6 illustrates a method of restoring a local machine. At 600, the time t for which the backup is to be made is input. At 602, a selected machine is dropped from the environment (e.g., cluster). At 604, a check is made to determine if the machine has been dropped. At 606, if successful, a search is performed for the backup files at time t. At 608, if found, the machine is restored locally, as indicated at 610. At 612, if the restore operation (e.g., SQL) succeeds, success of this restore operation is sent to the coordinator, as indicated at 614. At 616, this portion of the restore service then ends. Alternatively, if the machine drop is unsuccessful (at 604), or the backup files are not found (at 608), or the local machine is not restored (at 612), flow is to 618 to take the database offline. An error message can then be sent to the coordinator.

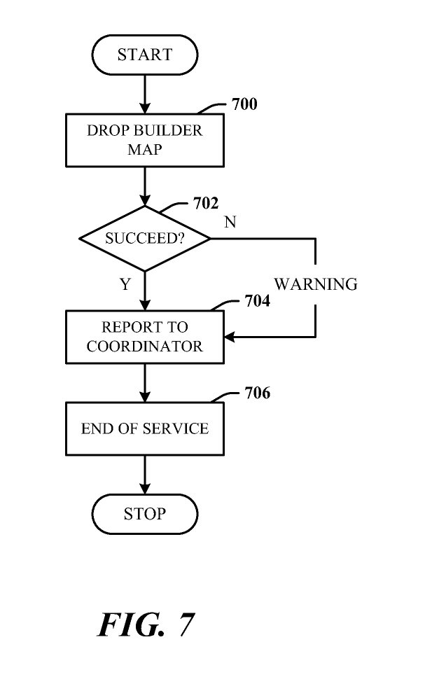

FIG. 7 illustrates a method of processing master machines at the coordinator level. At 700, the builder map is deleted. At 702, a check is made by the system to determine if the drop was successful. If so, flow is to 704 to report this to the coordinator. This portion of the restore service then ends, at 706. Alternatively, at 702, if dropping the builder map is unsuccessful, a warning message is sent to the coordinator, at 704.

More specifically, in the event of data loss on the GPM partition, the partition management and reconfiguration related can be reconstructed from information stored on the data machines themselves. Following is examples of steps that can be taken to restore/rebuild the cluster master partition: block all partition and replica creation at the partition manager (coordinator), send a request to every local machine to send a list of all replicas on the local machine. For each replica, send the committed or proposed configuration epoch values, the committed or proposed configurations, and whether the replica is currently acting as the primary.

The configuration epoch (CE) is different than the epoch employed in a commit sequence number (CSN). The configuration epoch is a monotonically increasing value in the most significant bits and includes the machine id (identifier) of the machine that generated the CE in the least significant bits. Two concurrent reconfigurations that attempt to use the same CSN epoch will be distinguishable by the CE, and only one will win, thereby linking the CSN epoch to the winning CE.

The CSN is a tuple (e.g., epoch, number) employed to uniquely identify a committed transaction in the system. The number component is increased at the transaction commit time. The changes (modifications) are committed on the primary and secondary replicas using the same CSN order. The CSNs are logged in the database system transaction log and recovered during database system crash recovery. The CSNs allow the replicas to be compared during failover.

The latest configuration for a partition can be determined when, for a given configuration X, a quorum of X replicas report the same proposed configuration, the same committed configuration, or no proposed configuration, a replica reports to be acting as the primary, in which case the replica is known to have the latest configuration. Once the latest configurations have been determined, the primary master resumes normal operation and the periodic tasks will induce the appropriate reconfigurations, replica adds/drops, etc.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

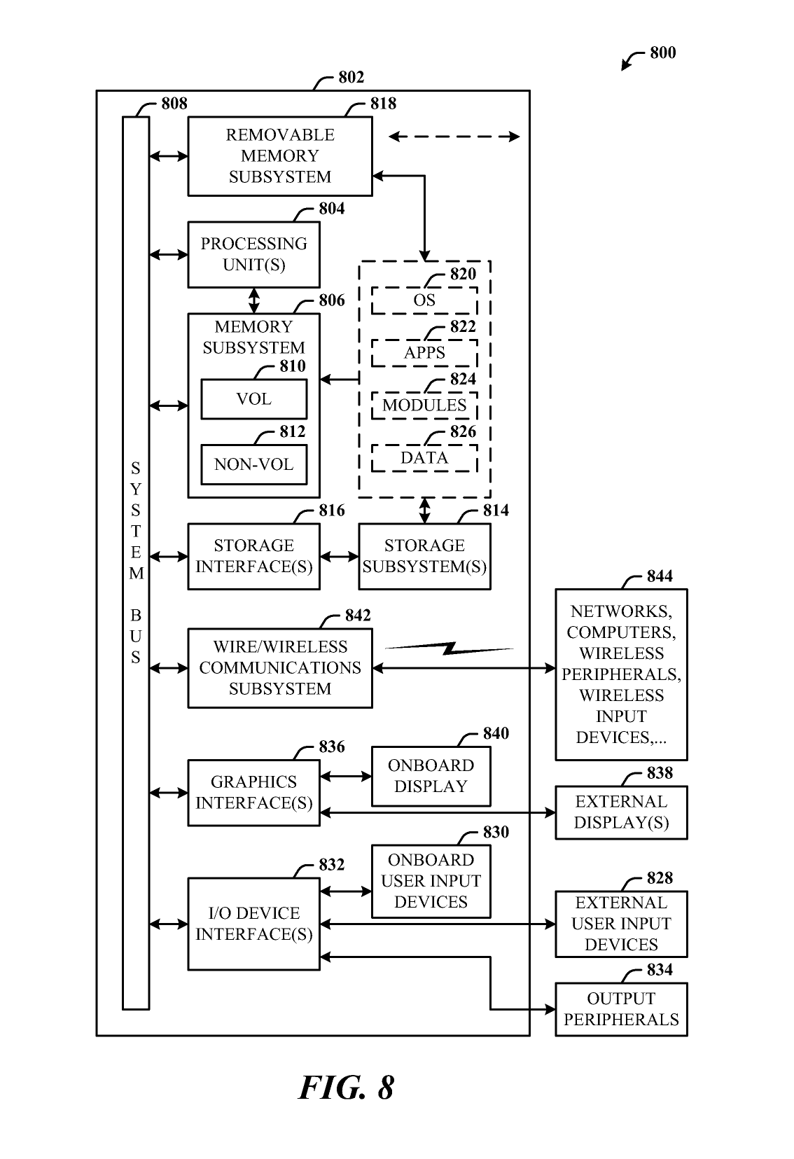

Referring now to FIG. 8, there is illustrated a block diagram of a computing system 800 operable to execute fast cluster restore using backups and rebuild in accordance with the disclosed architecture. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

As a local machine, the one or more application programs 822, other program modules 824, and program data 826 can include the components of and entities of the system 100 of FIG. 1, the flow diagram, entities and components of the flow diagram 200 of FIG. 2, and the methods represented by the flow charts of FIGS. 3-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network machines, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can be practiced in distributed computing environments where certain tasks are performed by remote processing devices that are linked through a communications network. In a distributed computing environment, program modules can be located in local and/or remote storage and/or memory system.

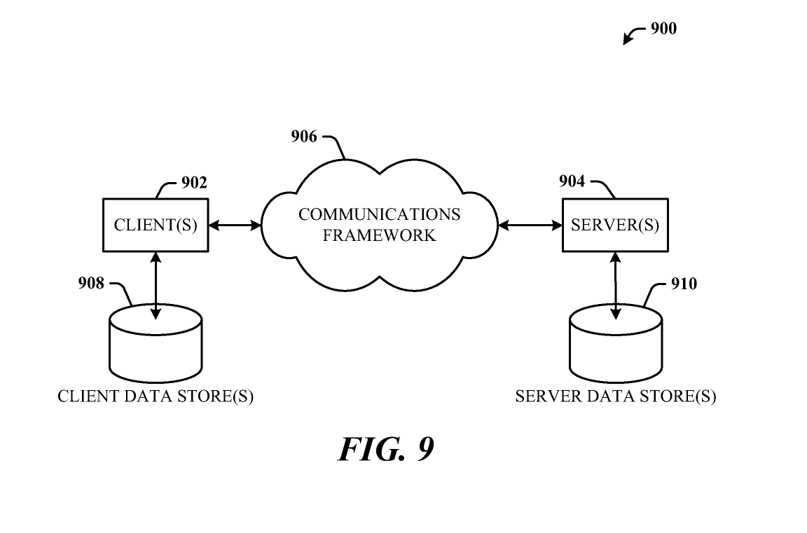

Referring now to FIG. 9, there is illustrated a schematic block diagram of a computing environment 900 that performs fast cluster recovery using the disclosed backup and rebuild architecture. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented database management system having a physical storage media, comprising:
a restore component that restores replicas of a distributed database partition of a local machine; and
a rebuild component that rebuilds the replicas of distributed database partition.

2. The system of claim 1, wherein the restore component restores the replicas concurrently.

3. The system of claim 1, wherein the replicas are restored using a structured query language (SQL) restore operation.

4. The system of claim 1, wherein the rebuild component rebuilds the partition to a point of common transactional consistency among all replicas.

5. The system of claim 1, wherein the replicas are restored using local backup data.

6. The system of claim 1, wherein the restore component retrieves local backup data relative to a previous point in time for recovering the cluster to the point in time.

7. The system of claim 1, wherein the rebuild component detects configuration conflicts between replicas of partitions and selects the most recent configuration of the conflicted configurations.

8. The system of claim 1, wherein the restore component is a cluster restore service that further restores master machines based on consistency restored to local machine partitions.

9. The system of claim 1, further comprising a quorum loss tool that is invoked to fix partitions in a quorum loss state.

10. A computer-implemented database management system having a physical storage media, comprising:
a cluster restore service in a distributed database system that facilitates concurrent restoration of replicas of distributed database partitions at local machines; and
a rebuild component that rebuilds the distributed database partitions to common transactional consistency of the associated replicas for cluster-wide recovery.

11. The system of claim 10, wherein the cluster restore service retrieves local backup data relative to a previous point in time for restoring the replicas at the local machines.

12. The system of claim 10, wherein the cluster restore service further facilitates rebuild of master replicas from partition state stored in the local machines.

13. The system of claim 10, further comprising a quorum loss tool that when invoked fixes replicas in a quorum loss state.

14. The system of claim 10, wherein the rebuild component detects configuration conflicts between partitions and selects a most recent configuration.

15. A computer-implemented database management method employing a processor and memory, comprising:
initiating restore operations concurrently to replicas of local machines due to a failure in a cluster;
applying backup data to the replicas of the local machines as part of the restore operations; and
rebuilding the replicas to common transactional consistency.

16. The method of claim 15, further comprising rebuilding master replicas of the cluster based on the transactionally consistent local replicas.

17. The method of claim 15, further comprising detecting conflicting configurations between various local partition maps.

18. The method of claim 17, further comprising selecting a most recent configuration for use by replicas associated with the conflicting configurations.

19. The method of claim 15, further comprising:
dropping the local machines from the cluster as part of the restore operations based on a cluster restore service list;
restoring the replicas by applying the backup data; and
deploying a regular service list and rebuilding of the replicas based on the regular service list.

20. The method of claim 15, further comprising invoking a quorum loss tool to fix replicas in a quorum loss state.
